(19) United States
(12) Patent Application Publication
(10) Pub. No.: US 2012/0288648 A1
(43) Pub. Date: Nov. 15, 2012

(54) Burp Cloth with Multiple Layers and Methods of Manufacturing Same

(75) Inventors: James Troy Shull, Plano, TX (US); Matthew Curry Shull, Naperville, IL (US)

(73) Assignee: BEAR IN MIND COMPANY, Austin, TX (US)

(21) Appl. No.: 13/106,222

(22) Filed: May 12, 2011

(51) Int. Cl. A41B 13/10; B32B 7/00; B23P 11/00; B32B 7/08

(52) U.S. Cl. 428/35.2; 428/193; 428/188; 428/99; 428/100; 29/428

(57) ABSTRACT

The disclosed principles provide a multiple layered cloth with absorbent layers and moisture barrier layers attached together. With multiple layers attached as disclosed herein, a parent can burp a baby on the cloth several times with just one burp cloth. The layers that are moisture barriers prevent any liquid from seeping through the cloth and onto the parent's skin or clothing. In one embodiment, a cloth may comprise a first portion having an absorbent layer and a moisture barrier layer adjacent to, and coextensive with, the absorbent portion of the first portion. Such a cloth may also include a second portion having an absorbent layer and a moisture barrier layer adjacent to, and coextensive with, the absorbent portion of the second portion. At least one edge of the first portion is attached to a corresponding edge of the second portion such that the moisture barrier layer of the first portion faces the absorbent layer of the second portion, and wherein the first portion.

### TECHNICAL FIELD

The present disclosure relates generally to burp cloths, and more specifically to multiple layer burp cloths for use by infants/babies, as well as other uses.

### BACKGROUND

After an infant/baby has finished feeding, a parent or caretaker will burp the infant/baby to get rid of the air that was swallowed during the feeding process. Since some spittle or milk or another liquid may come out of the baby's mouth during burping, a parent or caretaker will often have a burp cloth available to catch the liquid.

Structurally, the burp cloths are typically comprised of a material that can absorb the regurgitated liquid. Cotton, terry cloth, or cotton blends are common materials used in burp cloths. The tactility and thickness of the material will vary depending on the manufacturer. Once the baby has regurgitated some spittle or milk, the parent or caretaker may need to replace the burp cloth with another clean, sanitary burp cloth and therefore must have several burp cloths available. Furthermore, most burp cloths are usually comprised of a single layer of material. When the baby is burped the spittle or milk, depending on the amount, could seep through the burp cloth and onto the parent/caretaker's skin or garment. Accordingly, what is needed in the art is a burp cloth which can be used more than once.

### SUMMARY

Rather than using single use burp cloth, the principles of the present disclosure allow the use of just one burp cloth that has multiple layers with some layers that are moisture resistant being attached together, one or more (or none) of which may be removed depending on the method of attachment. With multiple layers, the parent can burp the baby several times with just one burp cloth, as opposed to having several burp cloths; plus the layers which are moisture resistant prevent any liquid from seeping through the burp cloth and onto the parent's skin or clothing.

In one embodiment, a multiple layered cloth is provided, which may comprise a first portion having an absorbent layer and a moisture barrier layer adjacent to, and coextensive with, the absorbent portion of the first portion. Such a cloth may also include a second portion having an absorbent layer and a moisture barrier layer adjacent to, and coextensive with, the absorbent portion of the second portion. In such embodiments, at least one edge of the first portion is attached to a corresponding edge of the second portion such that the moisture barrier layer of the first portion faces the absorbent layer of the second portion, and wherein the first portion.

In another embodiment, a multiple layered cloth is disclosed which may comprise a first portion having a first absorbent layer and a second absorbent layer coextensive with the first absorbent layer, and further having a moisture barrier layer located between, coextensive with, and adjacent to the first and second absorbent layers. Such a cloth may also comprise a second portion having a first absorbent layer and a second absorbent layer coextensive with the first absorbent layer, and further having a moisture barrier layer located between, coextensive with, and adjacent to the first and second absorbent layers. In such embodiments, at least one edge of the first portion is attached to a corresponding edge of the second portion.

In yet another embodiment, a method of manufacturing a multiple layered cloth is disclosed. Such a method may comprise providing a first portion having an absorbent layer and a moisture barrier layer adjacent to, and coextensive with, the absorbent layer, and providing a second portion having an absorbent layer and a moisture barrier layer adjacent to, and coextensive with, the absorbent layer of the second portion. Such a method may then provide for facing the moisture barrier layer of the first portion against the absorbent layer of the second portion. Such methods may also then provide for attaching at least one edge of the first portion to a corresponding edge of the second portion.

In sum, a multiple layered, moisture resistant burp cloth as disclosed herein is more flexible than a traditional burp cloth, and far more convenient than carrying multiple distinct burp cloths in preparation for all potential circumstances. Moreover, parents no longer need to buy several burp cloths, and can instead just buy one of the disclosed multiple layered, moisture resistant burp cloths, which can be used several times to burp the baby.

### BRIEF DESCRIPTION OF THE DRAWINGS

FIG. 1 illustrates one embodiment of a burp cloth according to the disclosed principles, which is comprised of six layers, each with substantially the same lengths and widths;

FIGS. 2a and 2b illustrate the six layers of the burp cloth illustrated in FIG. 1, which are attached along three and/or four edges to form a burp cloth constructed according to the disclosed principles;

FIG. 2c illustrates a side view of the layers of the burp cloth illustrated in FIG. 1;

FIG. 3 illustrates one embodiment of a burp cloth according to the disclosed principles, which is comprised of four layers, each with substantially the same lengths and widths;

FIGS. 4a and 4b illustrate the four layers of the burp cloth illustrated in FIG. 3, which are attached along one set of edges of the layers to form a burp cloth constructed according to the disclosed principles;

FIG. 4c illustrates a side view of the layers of the burp cloth illustrated in FIG. 3;

FIG. 5 illustrates one embodiment of a burp cloth according to the disclosed principles, which is comprised of six layers, each with substantially the same lengths and widths;

FIGS. 6a and 6b illustrate the six layers of the burp cloth illustrated in FIG. 5, which are attached along three and/or four edges to form a burp cloth constructed according to the disclosed principles; and

FIG. 6c illustrates a side view of the layers of the burp cloth illustrated in FIG. 5;

### DETAILED DESCRIPTION

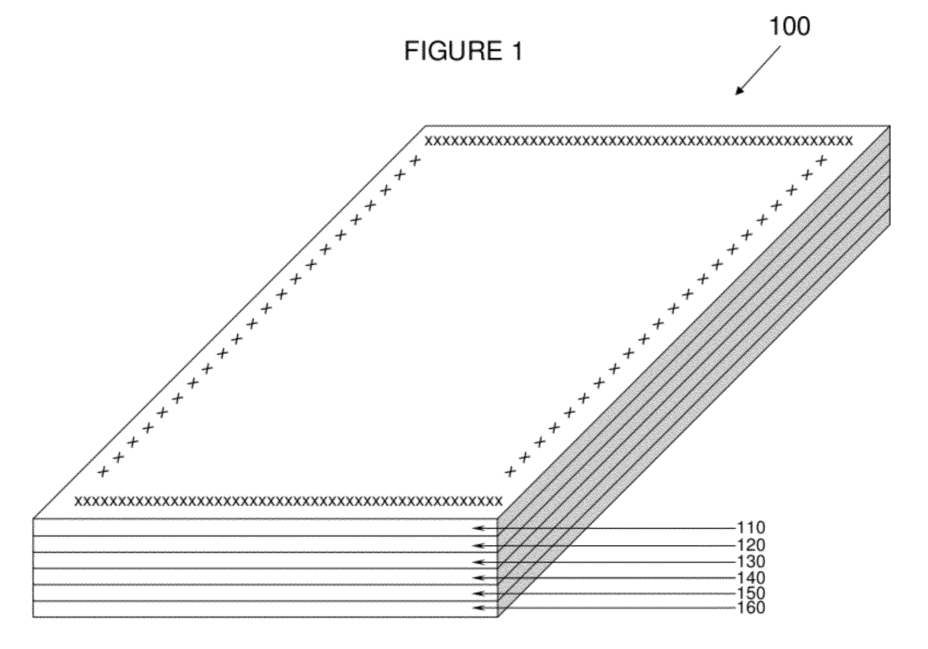

FIG. 1 illustrates an exemplary embodiment for a burp cloth 100 constructed according to the disclosed principles. Illustrated items of the burp cloth 100 in FIG. 1 include, in this embodiment, six different layers, one over another:

Layer 110

Layer 120

Layer 130

Layer 140

Layer 150

Layer 160

Burp cloth 100 is comprised of layers 110, 120, 130, 140, 150, and 160 each of which have substantially the same dimensions along their widths and lengths, as illustrated in FIG. 1. In addition, in this embodiment, layer 110 has four sides (110a, 110b, 110c and 110d), layer 120 has four sides (120a, 120b, 120c and 120d), layer 130 has four sides (130a, 130b, 130c and 130d), layer 140 has four sides (140a, 140b, 140c and 140d), layer 150 has four sides (150a, 150b, 150c and 150d), and layer 160 has four sides (160a, 160b, 160c and 160d). Each of the layers 110, 120, 130, 140, 150, 160 having four sides is merely illustrative, and thus layers have any number of sides, or no sides per se, such as with round- or elliptical-shaped burp cloths, are also envisioned and fall within the scope of the present disclosure.

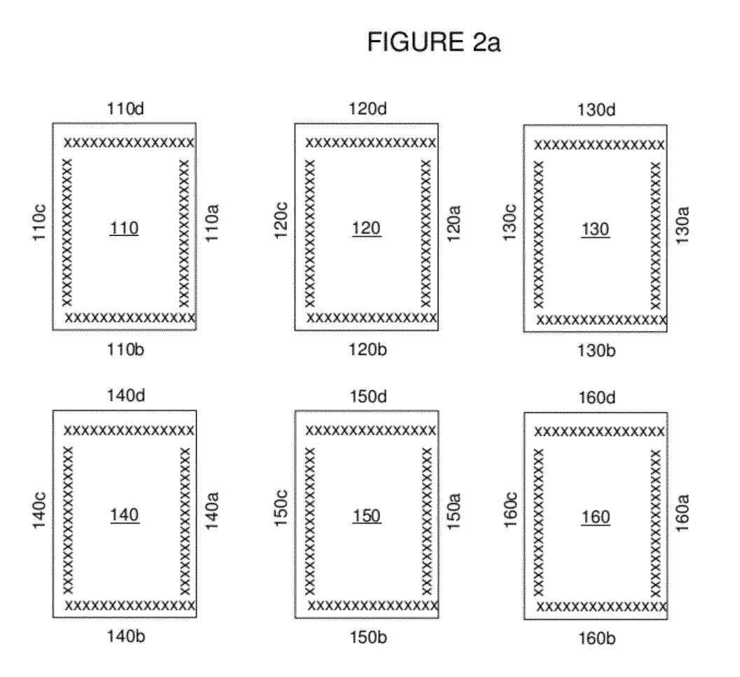

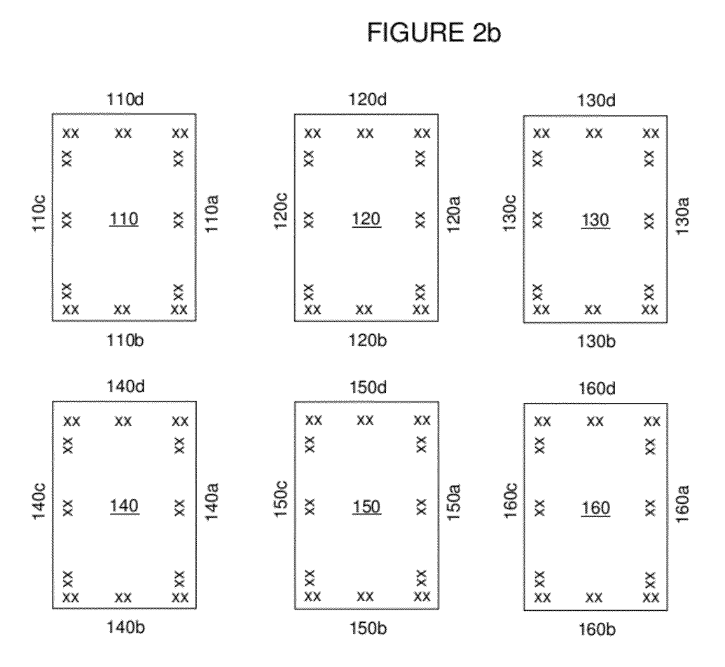

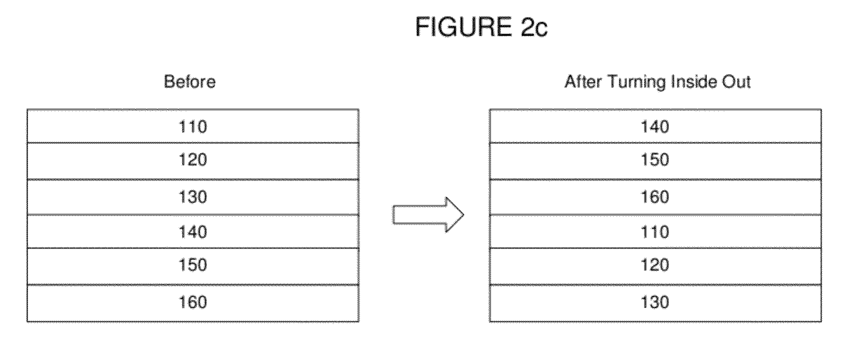

FIGS. 2a and 2b illustrate the individual layers 110, 120, 130, 140,150, and 160, and the exemplary area of attachment. The “X” in the figures represents the area(s) of attachment. FIG. 2a shows the areas of attachment substantially along the entire edges, while FIG. 2b shows the areas of attachment only partially along the edges. In this embodiment, edges 110a, 120a, 130a, 140a, 150a, 160a are attached together, and edges 110b, 120b, 130b, 140b, 150b, 160b are attached together. Also, edges 110c, 120c, 130c, 140c, 150c, 160c are attached together, edges 110d, 120d, and 130d are attached together, and edges 140d, 150d, and 160d are attached together. Attaching the layers as described above creates a pocket.

Layers 110, 130, 140 and 160 may be comprised of an absorbent material such as cotton, while layers 120 and 150 may be comprised of a moisture barrier comprising a resistant material such as Gore Tex®, vinyl, polyurethane laminate (PUL), or other moisture resistant material, even including spray-on materials. As used herein, the term “moisture barrier” means a material or materials that is/are moisture resistant, moisture wicking, or moisture blocking, depending on the specific material employed for the moisture barrier. What is important is that the moisture barrier does not allow moisture from the spittle/spit-up to penetrate through the moisture barrier.

Layer 120 acts as a moisture barrier between layers 110 and 130 while layer 150 acts as a moisture barrier between layers 140 and 160. As such, if a baby regurgitated on layer 110 while layer 160 was against the parent's skin or clothing, the liquid would be substantially absorbed by layer 110 and blocked by moisture barrier layer 120. The parent could then turn the burp cloth inside out, via the pocket, such that layers 130 and 140 are the outermost layers as shown in FIG. 2c. Thus, a burp cloth constructed in accordance with the disclosed principles does not provide for simply flipping over the outer soiled layer as seen in conventional burp cloths, since that flipped outer layer could still be soaked through and thus moisture exposed on both surfaces of the soiled layer. In stark contrast, a burp cloth as disclosed herein provides not only a new, clean surface on which to lay a baby's face, it actually provides an entirely different piece of material for that clean, new surface.

The burp cloth can be used multiple times instead of once, as with a traditional burp cloth. The baby could then be burped on layer 130, while layer 140 is against the parent's skin or clothing. If the baby only burped one time on the burp cloth, the parent could still turn the burp cloth inside out and stow it in a purse or diaper bag, thereby preventing the liquid on the burp cloth from contacting another object in the purse or diaper bag, which is a more sanitary method of stowing a soiled burp cloth. A traditional, soiled burp cloth would need to be placed in a plastic bag or some other moisture resistant vessel to prevent the contents of the burp cloth from contacting another object. This disclosed burp cloth is self-contained and need not be placed in a plastic bag or some other moisture resistant vessel after it has been soiled.

The method of attachment could be, but is not limited to, stitching, zippers, snaps, Velcro®, loops of material, buttons, or ties. The method of attachment along edges 110a, 120a, 130a, 140a, 150a, and 160a may, but need not be, the same method of attachment used to attach edges 110b, 120b, 130b, 140b, 150b, and 160c.

In embodiments in which buttons are used to fasten the layers illustrated in FIG. 1, each of the layers may be comprised as follows:
Layer 160 top side: buttons along the attachment edges 160a, 160b, and 160c. The buttons may be inserted through the button hole of layer 110, 120, 130, 140, and 150 and the button of layer 160 and be visible on the top side of layer 110.
Layer 160 top side: buttons along the attachment edge 160d. The buttons may be inserted through the button hole of layer 140 and 150 and the button of layer 160 and be visible on the top side of layer 140.
Layer 130 top side: buttons along the attachment edge 130d. The buttons may be inserted through the button hole of layer 110 and 120 and the button of layer 130 and be visible on the top side of layer 110.

In addition to turning the burp cloth inside out, buttons would allow the parent to remove individual layers if soiled. A burp cloth with buttons may be more expensive to manufacture and may require more dexterity than some other method of attachment, however its versatility may outweigh its cost depending on the desires of the user. Of course, the above description of the embodiment illustrated in FIG. 1 is illustrative only, and variations to the above-described approach may also be included in a burp cloth constructed according to the disclosed principles.

In embodiments in which hook-and-loop fasteners (e.g., Velcro®) are used to fasten the layers illustrated in FIG. 1, each of the layers may be comprised as follows:
Layer 110 top side: hook-and-loop material may be included for aesthetics only, though not required on edges 110a, 110b, 110c, and 110d.
Layer 110 bottom side: hook-and-loop material on edges 110a, 110b, 110c, and 110d.
Layer 120 top and bottom sides: hook-and-loop material on edges 120a, 120b, 120c, and 120d.
Layer 130 top side: hook-and-loop material on edges 130a, 130b, 130c, and 130d.
Layer 130 bottom side: hook-and-loop material on edges 130a, 130b, and 130c. No attachment is on 130d.
Layer 140 top side: hook-and-loop material on edges 140a, 140b, and 140c. No attachment is on 140d.
Layer 140 bottom side: hook-and-loop material on edges 140a, 140b, 140c, and 140d.
Layer 150 top and bottom sides: hook-and-loop material on edges 150a, 150b, 150c, and 150d.
Layer 160 top side: hook-and-loop material on edges 160a, 160b, 160c, and 160d.
Layer 110 bottom side: hook-and-loop material may be included for aesthetics only, though not required on edges 160a, 160b, 160c, and 160d.

In addition to turning the burp cloth inside out, Velcro would allow the parent to remove individual layers, if soiled. A burp cloth with Velcro may be more expensive to manufacture than some other method of attachment. Plus, Velcro may tend to stick to other areas of the burp cloth, which may not be desirable, and thus the desires of a disclosed burp cloth having Velcro would be at the discretion of each user. Of course, the above description of the embodiment illustrated in FIG. 1 is illustrative only, and variations to the above-described approach may also be included in a burp cloth constructed according to the disclosed principles.

In embodiments in which zippers are used to fasten the layers illustrated in FIG. 1, each of the layers may be comprised as follows:
A single zipper connecting all six layers 110, 120, 130, 140, 150, 160 together along attachment edges 110a, 110b, 110c, 120a, 120b, 120c, 130a, 130b, 130c, 140a, 140b, 140c, 150a, 150b, 150c, 160a, 160b, and 160c;
A single zipper connecting layers 110, 120, and 130 together along attachment edges 110d, 120d, 130d and;
A single zipper connecting layers 140, 150, and 160 together along attachment edges 140d, 150d, and 160d.

In addition to turning the burp cloth inside out, zippers may allow the parent to remove individual layers if soiled. A burp cloth with zippers may be more expensive to manufacture and may require more dexterity than some other method of attachment, however its versatility may outweigh its cost depending on the desires of the user. Of course, the above description of the embodiment illustrated in FIG. 1 is illustrative only, and variations to the above-described approach may also be included in a burp cloth constructed according to the disclosed principles.

In embodiments in which stitching is used to fasten the layers illustrated in FIG. 1, each of the layers may be comprised as follows:
Layers 110, 120, 130, 140, 150, 160 are stitched together along attachment edges 110a, 110b, 110c, 120a, 120b, 120c, 130a, 130b, 130c, 140a, 140b, 140c, 150a, 150b, 150c, 160a, 160b, and 160c;
Layers 110, 120, and 130 are stitched together along attachment edges 110d, 120d, and 130d.
Layers 140, 150, and 160 are stitched together along attachment edges 140d, 150d, and 160d.

Stitching would not allow the parent to remove individual layers if soiled yet the burp cloth could still be turned inside out, however the structural strength of the burp cloth would be high. Also, a burp cloth with stitching may be the least expensive method of manufacturing and require less dexterity than some other method of attachment. Of course, the above description of the embodiment illustrated in FIG. 1 is illustrative only, and variations to the above-described approach may also be included in a burp cloth constructed according to the disclosed principles.

In embodiments in which snaps are used to fasten the layers illustrated in FIG. 1 (where each snap has a male and female part), each of the layers may be comprised as follows:
Layer 110 top side: male or female snaps may be included for aesthetics only, though not required on edges 110a, 110b, 110c, and 110d.
Layer 110 bottom side: male snaps on edges 110a, 110b, 110c, and 110d.
Layer 120 top and bottom sides: female snaps on edges 120a, 120b, 120c, and 120d.
Layer 130 top side: male snaps on edges 130a, 130b, 130c, and 130d.
Layer 130 bottom side: female snaps on edges 130a, 130b, and 130c. No attachment is on 130d.
Layer 140 top side: male snaps on edges 140a, 140b, and 140c. No attachment is on 140d.
Layer 140 bottom side: female snaps on edges 140a, 140b, 140c, and 140d.
Layer 150 top and bottom sides: male on edges 150a, 150b, 150c, and 150d.
Layer 160 top side: female on edges 160a, 160b, 160c, and 160d.
Layer 110 bottom side: male or female snaps may be included for aesthetics only, though not required on edges 160a, 160b, 160c, and 160d.

Snaps would allow the parent to remove individual layers instead of turning the burp cloth inside out if soiled. A burp cloth with snaps may be more expensive to manufacture than some other method of attachment, however its versatility may outweigh its cost depending on the desires of the user. Of course, the above description of the embodiment illustrated in FIG. 1 is illustrative only, and variations to the above-described approach may also be included in a burp cloth constructed according to the disclosed principles.

In embodiments in which loops of material are used to fasten the layers illustrated in FIG. 1, each of the layers may be comprised as follows:
Loops of material are inserted into the incisions made along 110a, 120a, 130a, 140a, 150a, and 160a.
Loops of material are inserted into the incisions made along 110b, 120b, 130b, 140b, 150b, and 160b.
Loops of material are inserted into the incisions made along 110c, 120c, 130c, 140c, 150c, and 160c.
Loops of material are inserted into the incisions made along 110d, 120d, and 130d.
Loops of material are inserted into the incisions made along 140d, 150d, and 160d.

Loops of material would allow the parent to remove individual layers instead of turning the burp cloth inside out if soiled. Since the loops of material are not permanently attached to any layer, they could get lost thereby preventing a means of securing all of the layers of the burp cloth, however the versatility of cloth loops may outweigh this possibility depending on the desires of the user. A burp cloth with loops of material may be more expensive to manufacture than some other method of attachment. Of course, the above description of the embodiment illustrated in FIG. 1 is illustrative only, and variations to the above-described approach may also be included in a burp cloth constructed according to the disclosed principles.

In embodiments in which ties are used to fasten the layers illustrated in FIG. 1, each of the layers may be comprised as follows:
Ties are sewn along the attachment edges of 160a, 160b, 160c, and 160d.
Ties are sewn along attachment edge 130d.
Ties along 160a are inserted into the incisions made along 110a, 120a, 130a, 140a, and 150a and used to secure the layers together.
Ties along 160b are inserted into the incisions made along 110b, 120b, 130b, 140b, and 150b and used to secure the layers together.
Ties along 160c are inserted into the incisions made along 110c, 120c, 130c, 140c, and 150c and used to secure the layers together.
Ties along 160d are inserted into the incisions made along 140d and 150d and used to secure the layers together.
Ties along 130d are inserted into the incisions made along 110d and 120d and used to secure the layers together.

In addition to turning the burp cloth inside out, ties would allow the parent to remove individual layers if soiled. A burp cloth with ties may be more expensive to manufacture than some other method of attachment, however its versatility may outweigh its cost depending on the desires of the user. Of course, the above description of the embodiment illustrated in FIG. 1 is illustrative only, and variations to the above-described approach may also be included in a burp cloth constructed according to the disclosed principles.

Burp cloth 100, although illustrated with six layers, is preferably comprised of at least four or more layers in order to create a pocket with at least two burping surfaces and a moisture resistant barrier between the parent's skin/clothing and the outer surface of the burp cloth. More layers (absorbent and moisture resistant) could be added, which would increase the number of burping surfaces. For aesthetic purposes, one may want to use more than four layers so that the absorbent layers appear on the outside of the burp cloth even when the cloth is turned inside out. With a four layer cloth constructed according to the disclosed principles, one of the moisture resistant layers will be exposed, which may not be desirable by the designer or manufacturer.

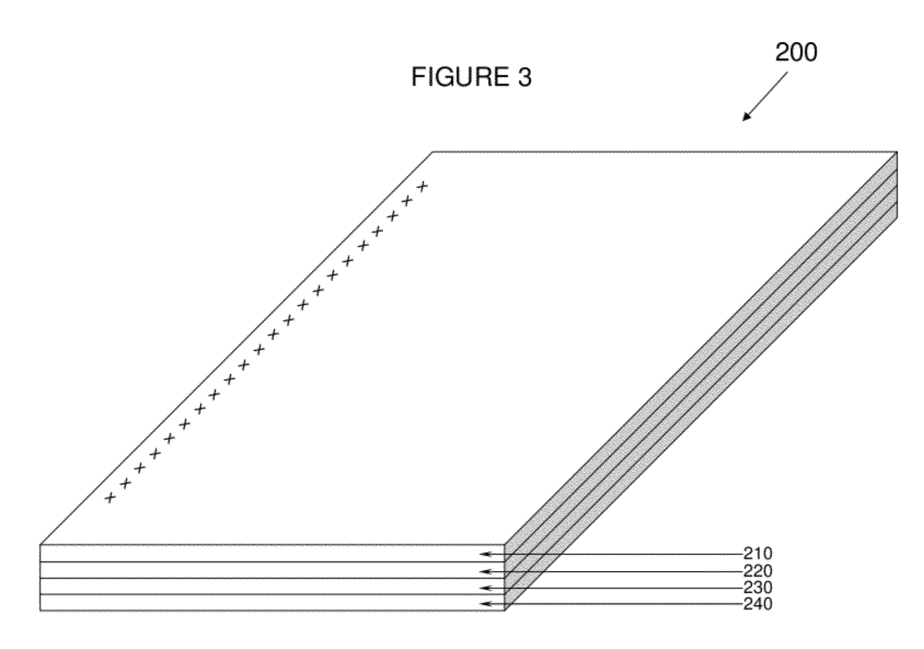

FIG. 3 illustrates an exemplary embodiment for a burp cloth 200 constructed according to the disclosed principles. Illustrated items of the burp cloth 200 in FIG. 3 include, in this embodiment, four different layer layers one over another:

Layer 210

Layer 220

Layer 230

Layer 240

Burp cloth 200 is comprised of layers 210, 220, 230, 240 each of which have substantially the same dimensions along their widths lengths, as illustrated in FIG. 3. In addition, in this embodiment, layer 210 has four edges or sides (210a, 210b, 210c and 210d), layer 220 has four sides (220a, 220b, 220c and 220d), layer 230 has four sides (230a, 230b, 230c and 230d), and layer 240 has four sides (240a, 240b, 240c and 240d). Each of the layers 210, 220, 230, 240 having four edges or sides is merely illustrative, and thus layers have any number of sides, or no sides per se, such as with round- or elliptical-shaped burp cloths, are also envisioned and fall within the scope of the present disclosure.

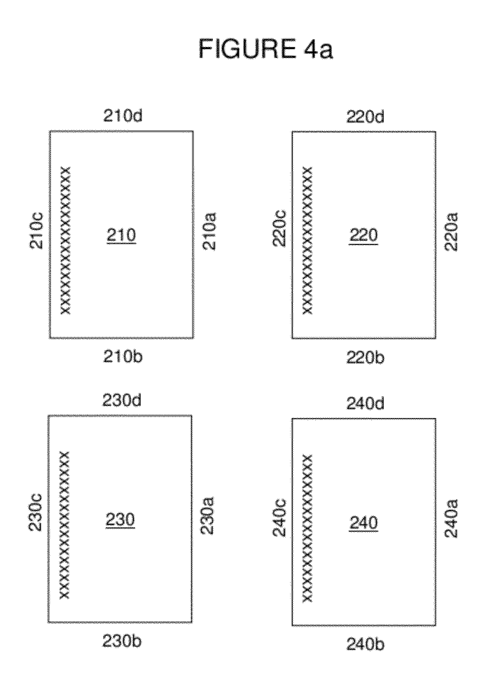

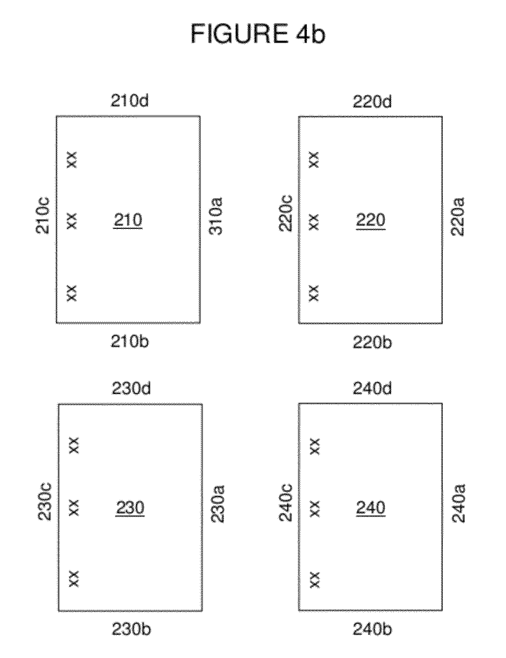

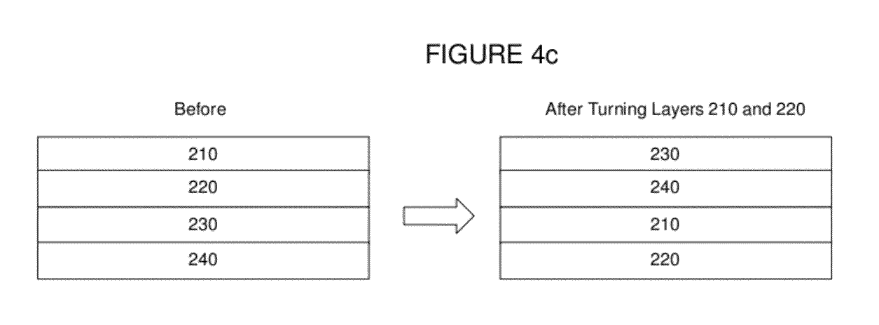

FIGS. 4a and 4b illustrate the individual layers 210, 220, 230, and 240 and the exemplary area(s) of attachment along one edge. The “X” represents the area of attachment. Edges or sides 210c, 220c, 230c, and 240c are attached together. Alternatively, edges 210b, 220b, 230b, and 240b could be attached together or edges 210a, 220a, 230a, and 240a could be attached together or edges 210d, 220d, 230d, and 240d could be attached together. Attaching the layers, and edges of layers, as described above allows the parent/caretaker to fold over the layers of the burp cloth much like the pages of a book. Layers 210 and 230 may be comprised of an absorbent material such as cotton while 220 and 240 may be comprised of a moisture resistant material such as Gore Tex or other examples as described above. Layer 220 acts as a moisture barrier between layers 210 and 230, while layer 240 acts as a moisture barrier between layers 230 and the parent's skin or clothing. If the baby regurgitated on layer 210 while layer 240 was against the parent's skin or clothing, the liquid would be substantially absorbed by layer 210 and blocked by moisture resistant layer 220. The parent could then turn layers 210 and 220 of the burp cloth inside such that layers 230 and 240 are the uppermost layers as shown in FIG. 4c. The burp cloth can be used multiple times instead of once like a traditional burp cloth. The baby could then be burped on layer 230 while layer 220 is against the parent's skin or clothing. If the baby only burped one time on the burp cloth, the parent could still turn layers 210 and 220 and stow it in a purse or diaper bag thereby preventing the liquid on the burp cloth from contacting another object in the purse or diaper bag which is a more sanitary method of stowing the burp cloth. A traditional, soiled burp cloth would need to be placed in a plastic bag or some other moisture resistant vessel to prevent the contents of the burp cloth from contacting another object. This disclosed burp cloth is self-contained and need not be placed in a plastic bag or some other moisture resistant vessel after it has been soiled.

The method of attachment could be but is not limited to stitching, zippers, snaps, Velcro®, loops of material, buttons, or ties.

In embodiments in which buttons are used to fasten the layers illustrated in FIG. 3, each of the layers may be comprised as follows:
Layer 240 top side: buttons along the attachment edges 240a, 240b, and 240c. The buttons may be inserted through the button hole of layer 210, 220, 230 and the button of layer 240 and be visible on the top side of layer 210.
   In addition to turning the layers like pages in a book, buttons would allow the parent to remove individual layers if soiled. A burp cloth with buttons may be more expensive to manufacture and may require more dexterity than some other method of attachment, however its versatility may outweigh its cost depending on the desires of the user. Of course, the above description of the embodiment illustrated in FIG. 3 is illustrative only, and variations to the above-described approach may also be included in a burp cloth constructed according to the disclosed principles.

In embodiments in which hook-and-loop fasteners (e.g., Velcro®) are used to fasten the layers illustrated in FIG. 3, each of the layers may be comprised as follows:
Layer 210 top side: hook-and-loop material may be included for aesthetics only, though not required.
Layer 210 bottom side: hook-and-loop material on edges 210c.
Layer 220 top side: hook-and-loop material on edges 220c.
Layer 220 bottom side: hook-and-loop material on edges 220c.
Layer 230 top side: hook-and-loop material on edges 230c.
Layer 230 bottom side: hook-and-loop material on edges 230c.
Layer 240 top side: hook-and-loop material on edges 230c.
Layer 240 bottom side: hook-and-loop material may be included for aesthetics only, though not required.
   In addition to turning the layers like pages in a book, Velcro would allow the parent to remove individual layers if soiled. A burp cloth with Velcro may be more expensive to manufacture than some other method of attachment. Plus, Velcro may tend to stick to other areas of the burp cloth which are not desirable, however the versatility of such a burp cloth may outweigh this possibility depending on the desire of the user. Of course, the above description of the embodiment illustrated in FIG. 3 is illustrative only, and variations to the above-described approach may also be included in a burp cloth constructed according to the disclosed principles.

In embodiments in which zippers are used to fasten the layers illustrated in FIG. 3, each of the layers may be comprised as follows:
A single zipper connecting all six Layers 210, 220, 230, 240 together along attachment edges 210c, 220c, 230c, and 240c; or
A zipper connect layers 210 and 220 along edges 210c and 220c and a zipper connecting layers 220 and 230 along edges 220c and 230c and a zipper connecting layers 230 and 240 along edges 230c and 240c.
   In addition to turning the layers like pages in a book, zippers may allow the parent to remove individual layers if soiled depending on the number and type of zipper used. A burp cloth with zippers may be more expensive to manufacture and may require more dexterity than some other method of attachment, however its versatility may outweigh its cost depending on the desires of the user. Of course, the above description of the embodiment illustrated in FIG. 3 is illustrative only, and variations to the above-described approach may also be included in a burp cloth constructed according to the disclosed principles.

In embodiments in which stitching is used to fasten the layers illustrated in FIG. 3, each of the layers may be comprised as follows:
Layers 210, 220, 230, 240 are stitched together along attachment edges 210c, 220c, 230c, and 240c.
   Stitching would not allow the parent to remove individual layers if soiled yet the layers could be turned like pages in a book. A burp cloth with stitching may be least expensive method of manufacturing and require less dexterity than some other method of attachment. Of course, the above description of the embodiment illustrated in FIG. 3 is illustrative only, and variations to the above-described approach may also be included in a burp cloth constructed according to the disclosed principles.

In embodiments in which snaps are used to fasten the layers illustrated in FIG. 3 (where each snap has a male and female part), each of the layers may be comprised as follows:
Layer 210 top side: male or female snaps may be included for aesthetics only, though not required.
Layer 210 bottom side: male snaps on edges 210c.
Layer 220 top side: female snaps on edges 220c.
Layer 220 bottom side: male snaps on edges 220c.
Layer 230 top side: female snaps on edges 230c.
Layer 230 bottom side: male snaps on edges 230c.
Layer 240 top side: female snaps on edges 240c.
Layer 240 top side: male or female snaps may be included for aesthetics only, though not required.
   In addition to turning the layers like pages in a book, snaps would allow the parent to remove individual layers if soiled. A burp cloth with snaps may be more expensive to manufacture than some other method of attachment, however its versatility may outweigh its cost depending on the desires of the user. Of course, the above description of the embodiment illustrated in FIG. 3 is illustrative only, and variations to the above-described approach may also be included in a burp cloth constructed according to the disclosed principles.

In embodiments in which loops of material are used to fasten the layers illustrated in FIG. 3, each of the layers may be comprised as follows:
Loops of material are inserted into the incisions made along 210c, 220c, 230c, and 240c.
   In addition to turning the layers like pages in a book, loops of material would allow the parent to remove individual layers if soiled. Since the loops of material are not permanently attached to any layer, they could get lost thereby preventing a means of securing all of the layers of the burp cloth. A burp cloth with loops of material may be more expensive to manufacture than some other method of attachment, however its versatility may outweigh its cost depending on the desires of the user. Of course, the above description of the embodiment illustrated in FIG. 3 is illustrative only, and variations to the above-described approach may also be included in a burp cloth constructed according to the disclosed principles.

In embodiments in which ties are used to fasten the layers illustrated in FIG. 3, each of the layers may be comprised as follows:
Ties are sewn along the attachment edges of 240c.
Ties along edge 240c are inserted into the incisions made along edges 210c, 220c, and 230c used to secure the layers together.
   In addition to turning the layers like pages in a book, ties would allow the parent to remove individual layers instead if soiled. A burp cloth with ties may be more expensive to manufacture than some other method of attachment, however its versatility may outweigh its cost depending on the desires of the user. Of course, the above description of the embodiment illustrated in FIG. 3 is illustrative only, and variations to the above-described approach may also be included in a burp cloth constructed according to the disclosed principles.

Burp cloth 200, although illustrated with four layers, may preferably be comprised of at least four or more layers with alternating absorbent and moisture resistant layers so that the baby is in contact with an absorbent layer and another absorbent layer is next to the parent's skin or clothing.

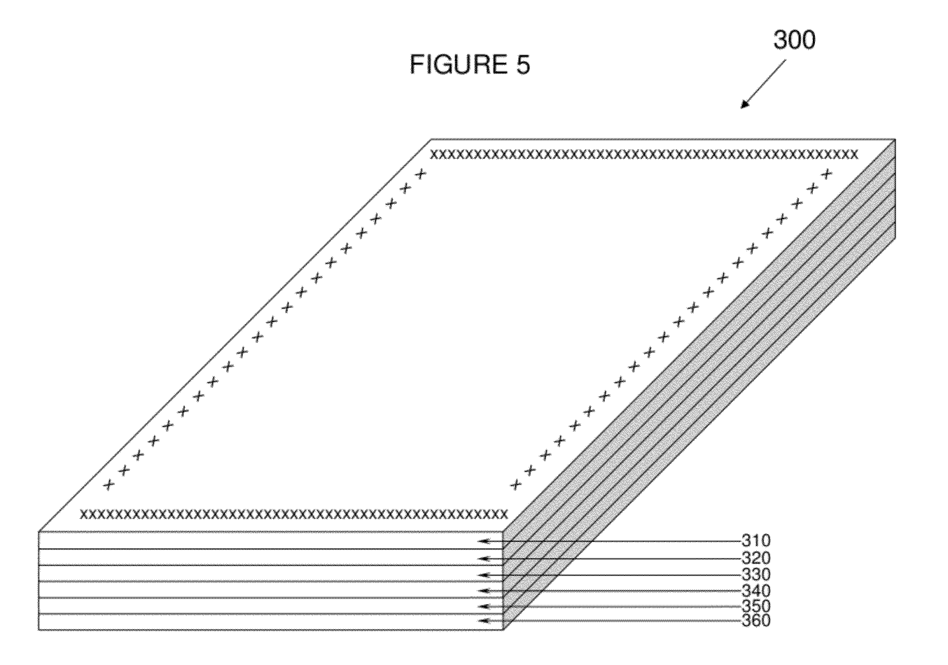

FIG. 5 illustrates an exemplary embodiment for a burp cloth 300 constructed according to the disclosed principles. Illustrated items of the burp cloth 300 in FIG. 5 include, in this embodiment, six different layers one over another:

Layer 310

Layer 320

Layer 330

Layer 340

Layer 350

Layer 360

Burp cloth 300 is comprised of layers 310, 320, 330, 340, 350, and 360 each of which have substantially the same dimensions along their widths and lengths, as illustrated in FIG. 5. In addition, in this embodiment, layer 310 has four sides (310a, 310b, 310c and 310d), layer 320 has four sides (320a, 320b, 320c and 320d), layer 330 has four sides (330a, 330b, 330c and 330d), layer 340 has four sides (340a, 340b, 340c and 340d), layer 350 has four sides (350a, 350b, 350c and 350d), and layer 360 has four sides (360a, 360b, 360c and 360d). Each of the layers 310, 320, 330, 340, 350, 360 having four sides is merely illustrative, and thus layers have any number of sides, or no sides per se, such as with round- or elliptical-shaped burp cloths, are also envisioned and fall within the scope of the present disclosure.

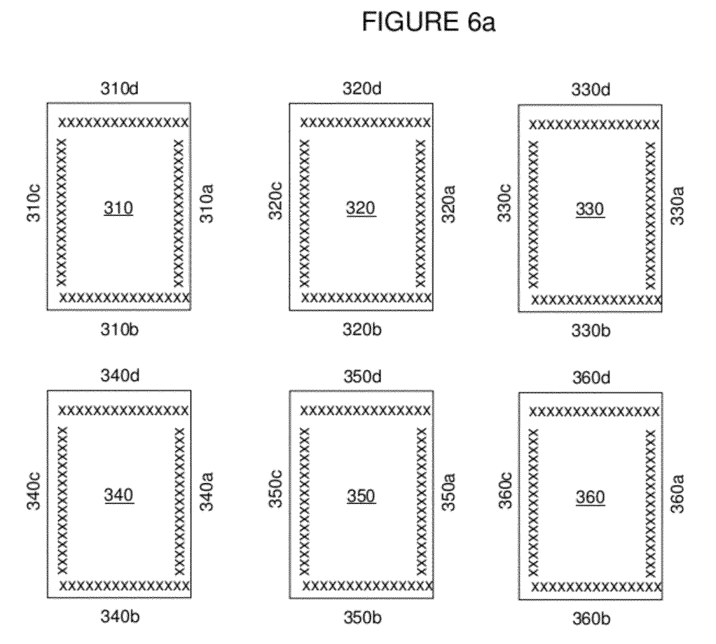

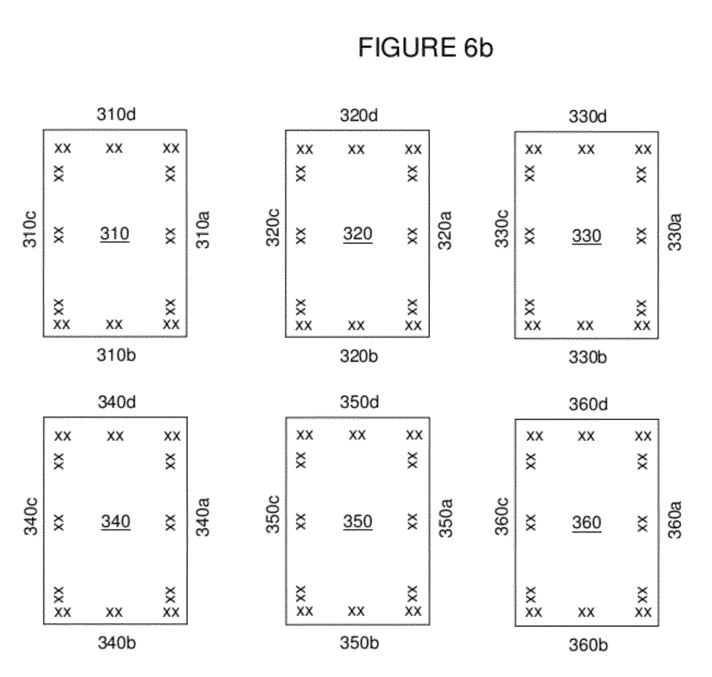

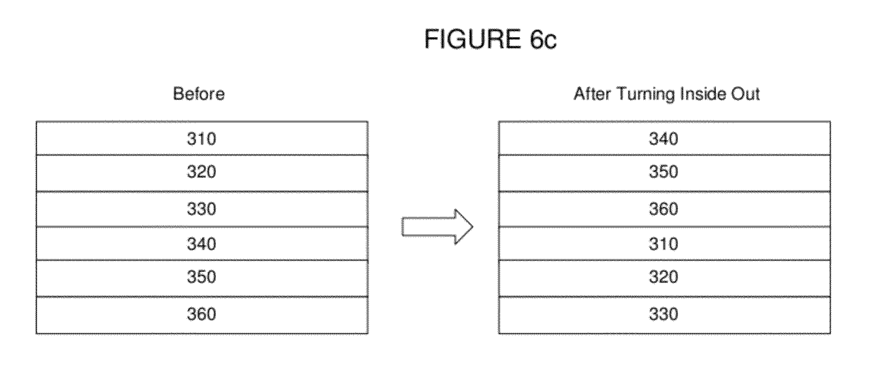

FIGS. 6a and 6b illustrate the individual layers 310, 320, 330, 340, 350, and 360, and the exemplary area of attachment. The “X” in the figures represents the area(s) of attachment. FIG. 6a shows the areas of attachment substantially along the entire edges, while FIG. 6b shows the areas of attachment only partially along the edges. In this embodiment, edges 310a, 320a, 330a, 340a, 350a, 360a are attached together, edges 310b, 320b, 330b are attached together, and edges 340b, 350b, and 360b are attached together. Also, edges 310c, 320c, 330c, 340c, 350c, 360c are attached together, edges 310d, 320d, and 330d are attached together, and edges 340d, 350d, and 360d are attached together. Attaching the layers as described above creates a tube.

Layers 310, 330, 340 and 360 may be comprised of an absorbent material such as cotton, while layers 320 and 350 may be comprised of a moisture barrier comprising a resistant material such as Gore Tex®, vinyl, polyurethane laminate (PUL), or other moisture resistant material, even including spray-on materials. As used herein, the term “moisture barrier” means a material or materials that is/are moisture resistant, moisture wicking, or moisture blocking, depending on the specific material employed for the moisture barrier. What is important is that the moisture barrier does not allow moisture from the spittle/spit-up to penetrate through the moisture barrier.

Layer 320 acts as a moisture barrier between layers 310 and 330 while layer 350 acts as a moisture barrier between layers 340 and 360. As such, if a baby regurgitated on layer 310 while layer 360 was against the parent's skin or clothing, the liquid would be substantially absorbed by layer 310 and blocked by moisture barrier layer 320. The parent could then turn the burp cloth inside out, via the tube, such that layers 330 and 340 are the outermost layers as shown in FIG. 6c. Thus, a burp cloth constructed in accordance with the disclosed principles does not provide for simply flipping over the outer soiled layer as seen in conventional burp cloths, since that flipped outer layer could still be soaked through and thus moisture exposed on both surfaces of the soiled layer. In stark contrast, a burp cloth as disclosed herein provides not only a new, clean surface on which to lay a baby's face, it actually provides an entirely different piece of material for that clean, new surface.

The method of attachment could be, but is not limited to, stitching, zippers, snaps, Velcro®, loops of material, buttons, or ties. The method of attachment along edges 310a, 320a, 330a, 340a, 350a, and 360a may, but need not be, the same method of attachment used to attach edges 310b, 320b, 330b, 340b, 350b, and 360c.

In embodiments in which buttons are used to fasten the layers illustrated in FIG. 5, each of the layers may be comprised as follows:
Layer 360 top side: buttons along the attachment edges 360a and 360c. The buttons may be inserted through the button hole of layer 310, 320, 330, 340, and 350 and the button of layer 360 and be visible on the top side of layer 310.
Layer 360 top side: buttons along the attachment edges 360b and 360d. The buttons may be inserted through the button hole of layer 340 and 350 and the button of layer 360 and be visible on the top side of layer 340.
Layer 330 top side: buttons along the attachment edges 330b and 330d. The buttons may be inserted through the button hole of layer 310 and 320 and the button of layer 330 and be visible on the top side of layer 310.

In addition to turning the burp cloth inside out, buttons would allow the parent to remove individual layers if soiled. A burp cloth with buttons may be more expensive to manufacture and may require more dexterity than some other method of attachment, however its versatility may outweigh its cost depending on the desires of the user. Of course, the above description of the embodiment illustrated in FIG. 5 is illustrative only, and variations to the above-described approach may also be included in a burp cloth constructed according to the disclosed principles.

In embodiments in which hook-and-loop fasteners (e.g., Velcro®) are used to fasten the layers illustrated in FIG. 5, each of the layers may be comprised as follows:
Layer 310 top side: hook-and-loop material may be included for aesthetics only, though not required on edges 310a, 310b, 310c, and 310d.
Layer 310 bottom side: hook-and-loop material on edges 310a, 310b, 310c, and 310d.
Layer 320 top and bottom sides: hook-and-loop material on edges 320a, 320b, 320c, and 320d.
Layer 330 top side: hook-and-loop material on edges 330a, 330b, 330c, and 330d.
Layer 330 bottom side: hook-and-loop material on edges 330a and 330c. No attachments are on 330b and 330d.
Layer 340 top side: hook-and-loop material on edges 340a, 340b, and 340c. No attachments are on 340b and 340d.
Layer 340 bottom side: hook-and-loop material on edges 340a, 340b, 340c, and 340d.
Layer 350 top and bottom sides: hook-and-loop material on edges 350a, 350b, 350c, and 350d.
Layer 360 top side: hook-and-loop material on edges 360a, 360b, 360c, and 360d.
Layer 310 bottom side: hook-and-loop material may be included for aesthetics only, though not required on edges 360a, 360b, 360c, and 360d.

In addition to turning the burp cloth inside out, Velcro would allow the parent to remove individual layers, if soiled. A burp cloth with Velcro may be more expensive to manufacture than some other method of attachment. Plus, Velcro may tend to stick to other areas of the burp cloth, which may not be desirable, and thus the desires of a disclosed burp cloth having Velcro would be at the discretion of each user. Of course, the above description of the embodiment illustrated in FIG. 5 is illustrative only, and variations to the above-described approach may also be included in a burp cloth constructed according to the disclosed principles.

In embodiments in which zippers are used to fasten the layers illustrated in FIG. 5, each of the layers may be comprised as follows:
A single zipper connecting all six layers 310, 320, 330, 340, 350, 360 together along attachment edges 310a, 310c, 320a, 320c, 330a, 330c, 340a, 340c, 350a, 350c, 360a, and 360c;
A single zipper connecting layers 310, 320, and 330 together along attachment edges 310b, 320b, and 330b;
A single zipper connecting layers 310, 320, and 330 together along attachment edges 340b, 350b, and 360b;
A single zipper connecting layers 310, 320, and 330 together along attachment edges 310d, 320d, 330d and;
A single zipper connecting layers 340, 350, and 360 together along attachment edges 340d, 350d, and 360d.

In addition to turning the burp cloth inside out, zippers may allow the parent to remove individual layers if soiled. A burp cloth with zippers may be more expensive to manufacture and may require more dexterity than some other method of attachment, however its versatility may outweigh its cost depending on the desires of the user. Of course, the above description of the embodiment illustrated in FIG. 5 is illustrative only, and variations to the above-described approach may also be included in a burp cloth constructed according to the disclosed principles.

In embodiments in which stitching is used to fasten the layers illustrated in FIG. 5, each of the layers may be comprised as follows:
Layers 310, 320, 330, 340, 350, 360 are stitched together along attachment edges 310a, 310c, 320a, 320c, 330a, 330c, 340a, 340c, 350a, 350c, 360a, and 360c;
Layers 310, 320, and 330 are stitched together along attachment edges 310b, 320b, and 330b;
Layers 340, 350, and 360 are stitched together along attachment edges 340b, 350b, and 360b;
Layers 310, 320, and 330 are stitched together along attachment edges 310d, 320d, and 330d and;
Layers 340, 350, and 360 are stitched together along attachment edges 340d, 350d, and 360d.

Stitching would not allow the parent to remove individual layers if soiled yet the burp cloth could still be turned inside out, however the structural strength of the burp cloth would be high. Also, a burp cloth with stitching may be the least expensive method of manufacturing and require less dexterity than some other method of attachment. Of course, the above description of the embodiment illustrated in FIG. 5 is illustrative only, and variations to the above-described approach may also be included in a burp cloth constructed according to the disclosed principles.

In embodiments in which snaps are used to fasten the layers illustrated in FIG. 5 (where each snap has a male and female part), each of the layers may be comprised as follows:
Layer 310 top side: male or female snaps may be included for aesthetics only, though not required on edges 310a, 310b, 310c, and 310d.
Layer 310 bottom side: male snaps on edges 310a, 310b, 310c, and 310d.
Layer 320 top and bottom sides: female snaps on edges 320a, 320b, 320c, and 320d.
Layer 330 top side: male snaps on edges 330a, 330b, 330c, and 330d.
Layer 330 bottom side: female snaps on edges 330a and 330c. No attachments are on 330b and 330d.
Layer 340 top side: male snaps on edges 340a and 340c. No attachments are on 340b and 340d.
Layer 340 bottom side: female snaps on edges 340a, 340b, 340c, and 340d.
Layer 350 top and bottom sides: male on edges 350a, 350b, 350c, and 350d.
Layer 360 top side: female on edges 360a, 360b, 360c, and 360d.
Layer 310 bottom side: male or female snaps may be included for aesthetics only, though not required on edges 360a, 360b, 360c, and 360d.

Snaps would allow the parent to remove individual layers instead of turning the burp cloth inside out if soiled. A burp cloth with snaps may be more expensive to manufacture than some other method of attachment, however its versatility may outweigh its cost depending on the desires of the user. Of course, the above description of the embodiment illustrated in FIG. 5 is illustrative only, and variations to the above-described approach may also be included in a burp cloth constructed according to the disclosed principles.

In embodiments in which loops of material are used to fasten the layers illustrated in FIG. 5, each of the layers may be comprised as follows:
Loops of material are inserted into the incisions made along 310a, 320a, 330a, 340a, 350a, and 360a.
Loops of material are inserted into the incisions made along 310b, 320b, and 330b.
Loops of material are inserted into the incisions made along 340b, 350b, and 360b.
Loops of material are inserted into the incisions made along 310c, 320c, 330c, 340c, 350c, and 360c.
Loops of material are inserted into the incisions made along 310d, 320d, and 330d.
Loops of material are inserted into the incisions made along 340d, 350d, and 360d.

Loops of material would allow the parent to remove individual layers instead of turning the burp cloth inside out if soiled. Since the loops of material are not permanently attached to any layer, they could get lost thereby preventing a means of securing all of the layers of the burp cloth, however the versatility of cloth loops may outweigh this possibility depending on the desires of the user. A burp cloth with loops of material may be more expensive to manufacture than some other method of attachment. Of course, the above description of the embodiment illustrated in FIG. 5 is illustrative only, and variations to the above-described approach may also be included in a burp cloth constructed according to the disclosed principles.

In embodiments in which ties are used to fasten the layers illustrated in FIG. 5, each of the layers may be comprised as follows:
Ties are sewn along the attachment edges of 360a, 360b, 360c, and 360d.
Ties are sewn along attachment edge 330b and 330d.
Ties along 360a are inserted into the incisions made along 310a, 320a, 330a, 340a, and 350a and used to secure the layers together.
Ties along 360b are inserted into the incisions made along 340b and 350b and used to secure the layers together.
Ties along 330b are inserted into the incisions made along 310b and 320b and used to secure the layers together.
Ties along 360c are inserted into the incisions made along 310c, 320c, 330c, 340c, and 350c and used to secure the layers together.
Ties along 360d are inserted into the incisions made along 340d and 350d and used to secure the layers together.
Ties along 330d are inserted into the incisions made along 310d and 320d and used to secure the layers together.

In addition to turning the burp cloth inside out, ties would allow the parent to remove individual layers if soiled. A burp cloth with ties may be more expensive to manufacture than some other method of attachment, however its versatility may outweigh its cost depending on the desires of the user. Of course, the above description of the embodiment illustrated in FIG. 5 is illustrative only, and variations to the above-described approach may also be included in a burp cloth constructed according to the disclosed principles.

Burp cloth 300, although illustrated with six layers, is preferably comprised of at least four or more layers in order to create a tube with at least two burping surfaces and a moisture resistant barrier between the parent's skin/clothing and the outer surface of the burp cloth. More layers (absorbent and moisture resistant) could be added, which would increase the number of burping surfaces. For aesthetic purposes, one may want to use more than four layers so that the absorbent layers appear on the outside of the burp cloth even when the cloth is turned inside out. With a four layer cloth constructed according to the disclosed principles, one of the moisture resistant layers will be exposed, which may not be desirable by the designer or manufacturer.

The physical dimensions of the layers and method of attachment are for illustrative purposes only. The embodiments in this application illustrate 4-sided polygon layers. One may also choose to use other multi-sided polygon, elliptical, or circular layers. The method of attaching the layers and area(s) of attachment can be determined by the designer or manufacturer. The side and or sides for attaching the layers can also be determined by the designer or manufacturer. Although the present disclosure has shown four layers or six layers in present illustrations, the burp cloth could preferably be comprised of at least four or more layers. The material, dimensions, spacing, and properties of the means of attachments (e.g. wood buttons, plastic buttons, metal buttons, plastic zipper, metal zipper, hook-and-loop, loop length, loop material, thread, stitch type, stitch count) can be determined by the designer or manufacturer. The absorbency and moisture resistance of the moisture barrier material may vary and can be determined by the designer or manufacturer.

Each layer of burp cloth 100, 200, and 300 may be comprised of different materials or thicknesses. Burp cloth 100, 200, and 300 may have absorbent layers comprised of various thicknesses of terry cloth or have some absorbent layers made of terry cloth and other absorbent layers made of bamboo or cotton chenille. Of course, other types of absorbent material(s) may also be employed. Burp cloth 100, 200, and 300 may have moisture barrier layers comprised of various thicknesses of Gore-Tex (2 ply or 3 ply) or have some moisture resistant layers made of Gore Tex and other moisture resistant layers made of nylon or other materials, such as those discussed above. The manufacturer may alternatively want to apply a moisture resistant substance, such as a silicone spray to one side of the absorbent material thereby eliminating the need for an individual moisture barrier layer.

In U.S. Pat. No. 4,050,099, David claims a protective garment that fits over the shoulder of the wearer and is secured to the wearer by ties or Velcro, and is comprised of multiple layers for the shoulder of the wearer. David's garment must be worn on the shoulder, while the disclosed burp cloth does not need to be worn by the wearer. Instead, a user can drape the burp cloth over his or her shoulder when burping a baby. He or she may also choose to have the baby sitting on his or her lap when burping, and simply wipe the baby's mouth with the burp cloth once some spittle or milk appears. Furthermore, David's garment only has one moisture resistant layer. Thus, once the baby has regurgitated some liquid, David's garment would be soiled and require cleaning. The disclosed burp cloth can have many moisture barrier layers, and can be used more than one time to burp the baby before being washed, as described above.

In U.S. Pat. No. 2,727,239, Simon claims a protective bib comprised of three rectangular layers with the outer layers being moisture absorbent and the inner layer moisture impervious. In stark contrast, the disclosed burp cloth can be made of any number of sides, or no sides per se, such as with round- or elliptical-shaped and requires at least four layers. Simon's protective bib is attached on all sides with binding tape. The disclosed burp cloth does not need to be attached on all sides and can be attached with several methods of attachment. Simon's bib is only comprised of two absorbent surfaces. If the baby soiled absorbent surface 14 and the bib were reversed such that absorbent surface 12 is the outermost layer, then the baby's clothes would be soiled by surface 14. The disclosed burp cloth not only protects the baby's clothes but also protects the parent's clothes and skin.

In U.S. Pat. No. 2,635,243, Eskey claims a reversible bib comprised of two layers with one layer comprised of absorbent material and one layer comprised of non-absorbent material. With Eskey's bib, the absorbent layer or the non-absorbent layer could be the outermost layer. If the baby soiled the absorbent layer, Eskey states the absorbent can be reversed with the soiled surface facing the body of the wearer (i.e., a baby) which means the baby's clothes will also be soiled by the contents of the soiled absorbent layer. Furthermore, Eskey allows the non-absorbent layer to the outer surface. If the baby spills or regurgitates his/her food, the non-absorbent layer will simply not absorb the contents and will result in the baby's clothes, the parent's clothes, or another surface such as the floor or high chair tray being soiled. The presently disclosed bib is designed to absorb the regurgitated contents of the baby and protect the baby's clothes, the parent's clothes and skin, and another surface from being soiled. With multiple layers of absorbent and moisture barrier materials, a soiled surface is never in contact with the baby's clothes and skin, or the parent's clothes and skin, because the moisture barrier prevents the contents of the soiled absorbent layer from seeping through to the baby's or the parent's clothes and skin. Also, the presently disclosed burp cloth can be made of any number of sides, or no sides per se such as with round- or elliptical-shaped and requires at least four layers.

While various embodiments of the principles disclosed herein have been described above, it should be understood that they have been presented by way of example only, and not limitation. For example, although certain materials are mentioned by example, other materials may also be used. Persons of ordinary skill in this art may implement the disclosed principles by varying one or more of the characteristics of the disclosed principles described above, without departing from the spirit and scope of the present disclosure. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A multiple layered cloth, comprising:
a first portion having an absorbent layer and a moisture barrier layer adjacent to, and coextensive with, the absorbent portion of the first portion;
a second portion having an absorbent layer and a moisture barrier layer adjacent to, and coextensive with, the absorbent portion of the second portion;
wherein at least one edge of the first portion is attached to a corresponding edge of the second portion such that the moisture barrier layer of the first portion faces the absorbent layer of the second portion, and wherein the first portion.

2. A multiple layered cloth according to claim 1, wherein the absorbent layer and the moisture barrier layer comprise distinct layers.

3. A multiple layered cloth according to claim 1, wherein two opposing edges of the first portion are attached to corresponding two opposing edges of the second portion, thereby forming a tubular passage between the first and second portions.

4. A multiple layered cloth according to claim 1, wherein three edges of the first portion are attached to corresponding three edges of the second portion, thereby forming a pocket between the first and second portions.

5. A multiple layered cloth according to claim 1, wherein the moisture barrier layer of the first or second portion comprises Gore-Tex, vinyl, polyurethane laminate (PUL), or a spray-on moisture barrier.

6. A multiple layered cloth according to claim 1, wherein the at least one edge of the first portion is attached to the corresponding edge of the second portion using one or more selected from the group consisting of buttons, snaps, hook-and-loop, loops of material, ties of material, zippers or stitching.

7. A multiple layered cloth, comprising:
a first portion having a first absorbent layer and a second absorbent layer coextensive with the first absorbent layer, and further having a moisture barrier layer located between, coextensive with, and adjacent to the first and second absorbent layers;
a second portion having a first absorbent layer and a second absorbent layer coextensive with the first absorbent layer, and further having a moisture barrier layer located between, coextensive with, and adjacent to the first and second absorbent layers; and
wherein at least one edge of the first portion is attached to a corresponding edge of the second portion.

8. A multiple layered cloth according to claim 7, wherein the first absorbent layer, the second absorbent layer and the moisture barrier layer of the first portion are distinct from one another.

9. A multiple layered cloth according to claim 7, wherein the first absorbent layer and the moisture barrier layer of the first portion are integral and distinct from the second absorbent layer of the first portion.

10. A multiple layered cloth according to claim 7, wherein two opposing edges of the first portion are attached to corresponding two opposing edges of the second portion, thereby forming a tubular passage between the first and second portions.

11. A multiple layered cloth according to claim 7, wherein three edges of the first portion are attached to corresponding three edges of the second portion, thereby forming a pocket between the first and second portions.

12. A multiple layered cloth according to claim 7, wherein the moisture barrier layer of the first or second portion comprises Gore-Tex, vinyl, polyurethane laminate (PUL), or a spray-on moisture barrier layer.

13. A multiple layered cloth according to claim 7, wherein the at least one edge of the first portion is attached to the corresponding edge of the second portion using one or more selected from the group consisting of buttons, snaps, hook-and-loop, loops of material, ties of material, zippers or stitching.

14. A method of manufacturing a multiple layered cloth, the method comprising:
providing a first portion having an absorbent layer and a moisture barrier layer adjacent to, and coextensive with, the absorbent layer;
providing a second portion having an absorbent layer and a moisture barrier layer adjacent to, and coextensive with, the absorbent layer of the second portion;
facing the moisture barrier layer of the first portion against the absorbent layer of the second portion; and
attaching at least one edge of the first portion to a corresponding edge of the second portion.

15. A method according to claim 14, wherein the attaching comprises attaching three edges of the first portion to three corresponding edges of the second portion, thereby forming a pocket between the first and second portions.

16. A method according to claim 14, wherein the attaching comprises attaching the at least one edge of the first portion to the corresponding edge of the second portion using one or more selected from the group consisting of buttons, snaps, hook-and-loop, loops of material, ties of material, zippers or stitching.

17. A method of manufacturing a multiple layered cloth, the method comprising:
providing a first portion having a first absorbent layer and a second absorbent layer coextensive with the first absorbent layer, and further having a moisture barrier layer located between, coextensive with, and adjacent to the first and second absorbent layers;
providing a second portion having a first absorbent layer and a second absorbent layer coextensive with the first absorbent layer, and further having a moisture barrier layer located between, coextensive with, and adjacent to the first and second absorbent layers; and
attaching at least one edge of the first portion to a corresponding edge of the second portion.

18. A method according to claim 17, wherein the attaching comprises attaching three edges of the first portion to three corresponding edges of the second portion, thereby forming a pocket between the first and second portions.

19. A method according to claim 17, wherein the attaching comprises attaching two opposing edges of the first portion to corresponding two opposing edges of the second portion, thereby forming a tubular passage between the first and second portions

20. A method according to claim 17, wherein the attaching comprises attaching the at least one edge of the first portion to the corresponding edge of the second portion using one or more selected from the group consisting of buttons, snaps, hook-and-loop, loops of material, ties of material, zippers or stitching.
